(19) United States
(12) Patent Application Publication
(10) Pub. No.: US 2026/0276594 A1
(43) Pub. Date: Sep. 17, 2026

(54) APPARATUS FOR TRAVERSING A STRUCTURE AND DETERMINING POSITIONAL DATA

(71) Applicant: EVOSONIC PTY LTD, Beverley, South Australia (AU)

(72) Inventor: Nicholas ABSALOM, Hindmarsh, South Australia (AU)

(21) Appl. No.: 19/166,953

(22) PCT Filed: Mar. 21, 2024
(86) PCT No.: PCT/AU2024/050254

§ 371 Date: Sep. 19, 2025

(30) Foreign Application Priority Data
Mar. 21, 2023 (AU) 2023900791

(51) Int. Cl. G01N 29/04

(52) U.S. Cl. CPC G01N 29/04; G01N 2291/106; G01N 2291/2634

(57) ABSTRACT

A surface position sensor is disclosed. The sensor comprises a sensor housing moveable across a surface of an elongate tubular walled body, the elongate tubular walled body defining an axial direction extending along a length of the walled body and a transverse circumferential direction extending along a circumference of the walled body and a three-degree-of-freedom force sensor for sensing circumferential movement of the sensor housing across the surface of the elongate tubular walled body. The sensor also comprises a processing module for receiving an output of a three-degree-of-freedom force sensor and determining a current circumferential position on the surface as the surface position sensor moves across the surface of the elongate tubular walled body and an indicator for indicating a current positioning of the surface position sensor relative to a reference circumferential position.

### PRIORITY DOCUMENTS

The present application claims priority from Australian Provisional Patent Application No. 2023900791 titled “APPARATUS FOR TRAVERSING A STRUCTURE AND DETERMINING POSITIONAL DATA” and filed on 21 Mar. 2023, the content of which is incorporated by reference in its entirety.

### TECHNICAL FIELD

Aspects of the disclosure relate to a position-defining apparatus for determining the position of the apparatus on fluid-carrying or fluid-containment structures adaptable to carry one or more sensors for collecting data relating to those structures.

### BACKGROUND

Non-destructive testing of structures for various characteristics is possible using one or more sensors in proximity to those structures during construction, immediately after completion, and over the structure's lifetime.

Various imperfections in steel structures include fracture, pitting, wear (preferential and localised or widely distributed), welding imperfections, impact damage (internal and external), the unintended adverse results of expansion and contraction, loss or loss or removal of coatings, and separation of jointed material as well as degradation resulting from general or microbial induced corrosion. The non-destructive testing of steel structures and associated welds can involve leak testing, liquid penetrant, magnetic particle, eddy current, radiography, laser alignment, magnetic flux leakage, and ultrasonic testing.

In structures made of concrete and other materials, various imperfections can be tested. The testing of structures can involve using magnetic particles, eddy currents, radiography, laser alignment, ultrasonic testing and visual acuity and experience.

Fluid-carrying or fluid-containment structures that may contain a fluid, such as tanks and the pipes that feed and empty those tanks, need to be structurally sound. However, over time the wall of pipes and tanks degrade, and imperfections in their surfaces can develop. Sometimes those imperfections develop on the internal and external surfaces or within the walls of the structure and are not necessarily detectable unless visually inspected. In some cases, the imperfection is not detectable despite the region being visible. There are various imperfections in fluid-carrying or fluid-containment structures, including fracture, pitting, wear (preferential and localised or widely distributed), welding imperfections, impact damage (internal and external), microbial-induced corrosion, the unintended adverse results of expansion and contraction, loss or removal of coatings, and separation of jointed material.

However, testing for the integrity and sufficiency of structures, particularly those of metal that store and communicate fluids sometimes at a pressure greater than the atmosphere, is time-consuming and labour-intensive due to the size of the structures and the length and diameter of the pipes, due in part to the physical form of the various sensors, which typically require manual placement by an operator and in some cases an operator's knowledgeable of the specific operational characteristics of the sensor and the environment in which the sensor is being used.

As an example, operators find it difficult to maintain awareness of the position of the sensor in relation to the structure leading to potentially repeating measurements of a portion of the structure. This can lead to inefficiencies and/or completely missing scanning or testing portions of the structure which can have serious consequences.

### SUMMARY

In one aspect, the present disclosure provides a surface position sensor comprising:
a sensor housing moveable across a surface of an elongate tubular walled body, the elongate tubular walled body defining an axial direction extending along a length of the walled body and a transverse circumferential direction extending along a circumference of the walled body;
a three-degree-of-freedom force sensor for sensing circumferential movement of the sensor housing across the surface of the elongate tubular walled body;
a processing module for receiving an output of a three-degree-of-freedom force sensor and determining a current circumferential position on the surface as the surface position sensor moves across the surface of the elongate tubular walled body; and
an indicator for indicating a current positioning of the surface position sensor relative to a reference circumferential position.

In another form, the sensor housing comprises a housing interface surface configured to facilitate movement of the sensor housing across the surface of the elongate tubular walled body.

In another form, the sensor housing interface surface comprises a low-friction surface.

In another form, the sensor housing interface surface is shaped in accordance with the curvature of the surface being measured.

In another form, the sensor housing is configured to be manually moveable across the surface of the elongate tubular walled body.

In another form, the surface position sensor further comprises a motive force arrangement adapted to move the sensor across the surface of the elongate tubular walled body.

In another form, the indicator provides a visual indication that changes appearance depending on a distance of the current circumferential position from the reference circumferential position.

In another form, the visual indication comprises an array of light emitting elements and wherein individual light emitting elements, or combinations of light emitting elements, illuminate to indicate the distance and direction of the current circumferential position with respect to the reference circumferential position.

In another form, the three-degree of-freedom force sensor is a non-contact force sensor.

In another form, the surface position sensor further comprises a translational sensor for sensing axial movement of the sensor housing and wherein the processing module is further configured to receive an output from the translational sensor and determine a current axial position on the surface as the surface position sensor moves across the surface of the elongate tubular walled body.

In another form, the translational sensor is a rotary encoder type sensor.

In another form, the indicator indicates the current positioning of the surface position sensor relative to a reference axial position.

In another form, the tubular walled body is a fluid carrying pipe.

In a second aspect, the present disclosure provides a sensing arrangement for determining a physical characteristic of a tubular wall structure, comprising:
the surface position sensor in accordance with the first aspect;
a non-destructive sensor operable to sense the physical characteristic of the tubular wall structure at a given surface position; and
a processing module to receive the surface position from the surface position sensor and the physical characteristic from the non-destructive sensor and output the physical characteristic for a given surface position.

In another form, the non-destructive sensor comprises:
a transceiver housing having a sensor surface;
a transceiver array operable to emit and receive energy through the sensor surface, wherein the sensor surface is shaped in accordance with the curvature of the surface being measured.

In another form, the transceiver array comprises ultrasonic transducers operable to emit ultrasonic energy through the sensor surface and into the tubular walled body and to receive reflected ultrasonic energy through the sensor surface.

In another form, the sensor surface is biased to contact with the surface of the tubular walled structure being sensed.

In another form, the physical characteristic of the tubular wall structure is the wall condition.

In another form, the sensor arrangement is configured to be manually moveable across the surface of the elongate tubular walled body.

In a third aspect, the present disclosure provides a method for determining the condition of a tubular walled body, comprising:
moving the sensor arrangement in accordance with the second aspect in accordance with a predetermined path covering a representative surface portion of the tubular walled body; and
determining the condition based on the variation in the physical characteristic measured by the sensor arrangement.

### BRIEF DESCRIPTION OF DRAWINGS

Embodiments of the present disclosure will be discussed with reference to the accompanying drawings wherein:

FIGS. 1A and 1B show cross-sectional and perspective views of an elongate tubular walled body in accordance with some embodiments;

FIG. 2 is a system overview diagram of a surface position sensor for determining a circumferential position of the sensor on the surface of a tubular walled body in accordance with some embodiments;

FIG. 3 is system overview diagram of a sensing arrangement for determining a physical characteristic around a circumferential portion of a tubular walled body comprising a non-destructive sensor and incorporating the surface position sensor illustrated in FIG. 2 in accordance with some embodiments;

FIG. 4 is a visual representation of the structural characteristics of a tubular walled body in the form of a pipe at a given axial location and showing the variation as a function of circumferential position in accordance with some embodiments;

FIG. 5 is a system overview diagram of a surface position sensor for determining both a circumferential and axial position of the sensor on the surface of a tubular walled body in accordance with some embodiments;

FIG. 6 is a system overview diagram of a sensing arrangement for determining a physical characteristic at a location on a tubular walled body comprising a non-destructive sensor and incorporating the surface position sensor illustrated in FIG. 5 in accordance with some embodiments;

FIG. 7 is a representation of a scanning process employing the sensing arrangement illustrated in FIG. 6 in accordance with some embodiments;

FIG. 8 is a visual representation of the structural characteristics of a tubular walled body corresponding to the scanned region shown in FIG. 7 in accordance with some embodiments;

FIG. 9 is a top perspective view of a surface position sensor in accordance with some embodiments;

FIG. 10 is an underside internal view of the sensor housing illustrated in FIG. 9 depicting a three-degree-of-freedom sensor in accordance with some embodiments;

FIG. 11 is an underside view of the surface position sensor illustrated in FIG. 9 showing a translational sensor in accordance with some embodiments;

FIG. 12 is an end on perspective view of the surface position sensor illustrated in FIG. 9 and further showing an additional adaptation arrangement for mounting or attaching a non-destructive sensor in accordance with some embodiments;

FIG. 13 is a top perspective view of a non-destructive sensor for non-destructive testing of a tubular walled body in accordance with some embodiments;

FIG. 14 is a top perspective view of a transceiver array forming the active detecting component of the non-destructive sensor illustrated in FIG. 13 in accordance with some embodiments;

FIGS. 15A and 15B are shown end and side views of a sensing arrangement for determining a physical characteristic of a tubular wall structure in accordance with some embodiments;

FIG. 16 is a representation of an electronic data processing, display and control module that may be used in combination with a surface position sensor or sensing arrangement in accordance with the present disclosure and in accordance with some embodiments; and

FIG. 17 is a composite display image showing a defect in the pipe and the location of that defect in accordance with some embodiments.

In the following description, like reference characters designate like or corresponding parts throughout the figures.

### DESCRIPTION OF EMBODIMENTS

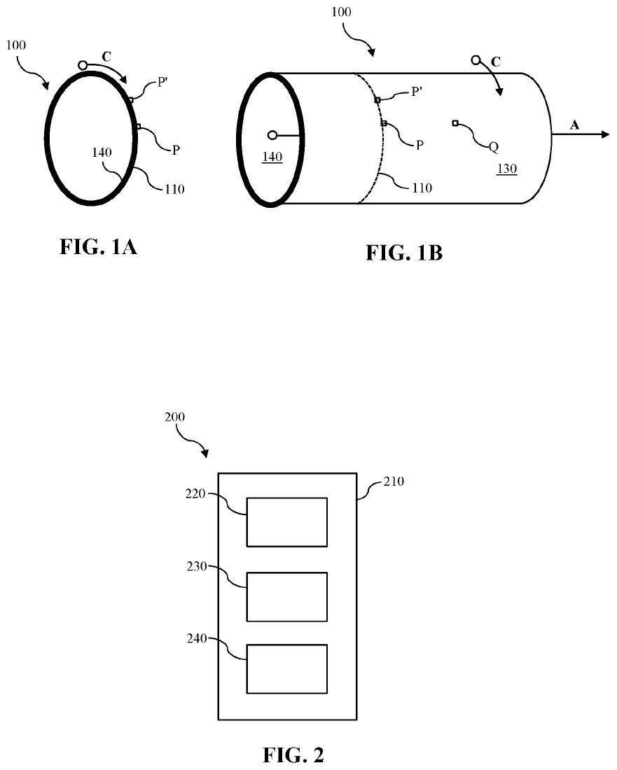

Referring now to FIGS. 1A and 1B, there are shown cross-sectional and perspective views of an elongate tubular walled body 100 (as best seen in FIG. 1A) which defines an axial direction (indicated by A) that extends along the length of the walled body 100. Extending transversely to the axial direction is a transverse circumferential direction that extends along a circumference of the body 100 (indicated by C). As shown in FIGS. 1A and 1B, the relevant circumference is the outer circumference 110 corresponding to the outer surface 130 of the walled body 100.

While in this example tubular walled body 100 is shown having a generally elliptical cross-section, it would be appreciated that the cross-section or cross-sectional profile may be circular (ie, having constant curvature) or indeed any other smoothly varying curvature (eg, elliptical or as would be described by a cubic spline interpolation representation or similar). Some examples of elongated tubular walled bodies contemplated to be within the scope of the present disclosure include, but are not limited to, pipes, channels, conduits, other pressure vessels for containing a fluid (eg, an elongate cylindrical tank), and pressure vessels configured to resist the pressure of a surrounding outside of the vessel (eg, a submarine or submerged elongate container or pipe).

A given position or location on the surface 130 of walled body 100 will have an associated circumferential position defined as the distance along the circumference with respect to a zero or reference point. Similarly, a given position or location on the outer surface 130 of walled body will have an associated axial position defined as the distance along the axial direction with respect to a zero or reference point. As shown in FIGS. 1A and 1B, locations P and P′ have different circumferential positions but the same axial position, while location Q has the same circumferential position as location P but a different axial position.

While the above discussion is with respect to the outer surface 130 of the walled body, it will be appreciated that locations on the inner surface 140 of tubular walled body 100 may similarly be described in terms of their circumferential position along the inner surface 140. Accordingly, throughout this description, a reference to the surface of an elongate tubular walled body may refer to either the inner or outer surface which will be apparent from the context.

As would be appreciated, to fully define a position or location in three-dimensional space typically requires three spatial coordinates (eg, cartesian coordinates of x, y and z or spherical coordinates of r, θ and φ). In the context of this disclosure, which is concerned with determining the position on the surface of a tubular walled body, the circumferential position and axial position will uniquely determine a location given that the radial distance from the centre of the tubular walled body will be defined by the actual surface of the walled body being measured.

Referring now to FIG. 2, there is shown a system overview diagram of a surface position sensor 200 for determining a circumferential position of the sensor of a tubular walled body according to some embodiments of the present disclosure. By way of overview, surface position sensor 200 comprises a sensor housing 210, a three-degree-of-freedom (DOF) force sensor 220, processing module 230 and an indicator 240 which will be described below.

In this example, sensor housing 210 is configured to be moveable across the surface of an elongate tubular walled body such as tubular walled body 100 of FIG. 1.

In an embodiment, the surface position sensor 100 housing comprises a sensor housing interface surface configured to interface with the surface of the walled body to facilitate movement of the sensor housing along or across the surface of the tubular walled body. In one example, the sensor housing interface surface is shaped in accordance with the curvature of the surface being measured. In one example, sensor housing interface surface is shaped in accordance with whether the surface position sensor 100 is measuring a generally concave inner surface or a generally convex outer surface of the walled body (or vice versa).

In one example, the housing interface surface comprises a low-friction surface. In one example, the low-friction surface is formed from hardened steel. In another example, the low-friction surface includes a Teflon or other low-friction coating material.

In another embodiment, water or other suitable fluid or lubricant may be directed to flow between the interface surface of the sensor housing and the walled body to reduce friction as the sensor housing is moved over the surface of the walled body.

In another example, the housing interface surface comprises three or more low-friction interface surface members, such as ball bearings captured in the sensor housing such that a portion of the ball bearing is exposed. In one example, three ball bearing housings and associated ball bearings are formed in a substantially triangular formation in the housing interface surface. In another example, there are four ball bearing housings and associated ball bearings with the ball bearing housings and associated ball bearings each located in the corner regions of a housing interface surface having a rectangular configuration.

In an embodiment, the sensor housing is made from a solid material such as aluminium which provides a rigid structure to which various elements are attached. However, any suitably rigid material may be used depending on requirements.

In one embodiment, the sensor housing is configured to be manually moveable across the surface of the walled body. In another embodiment, the surface position sensor further comprises a motive force arrangement adapted to move the sensor housing over the outer surface of the walled body. In one example, the sensor housing comprises a driven wheel arrangement where the drive shaft of an electric motor is coupled to the wheel's axle to cause the wheel's rotation. In one example, the driven wheel assembly is biased, so the driven wheel frictionally engages against the surface of the walled body.

In other examples, there can be more than one motor as long as the control of each motor accommodates the need to drive the sensor in a circumferential direction. The rate of movement created by the motor or motors can be controlled remotely or autonomously, and the rate of movement can range between 0 and 5 meters per second. In an example, where a friction-reducing fluid is used between the sensor housing and the walled body's surface, the flow rate and the fluid's reservoir size may limit the maximum movement rate and the circumferential length to be tested. In such a case, there may be a balance of sensor arrangement pressure on the structure and the maintainable fluid head pressure to maintain an adequate hydrodynamic force to reduce friction to an acceptable level. In various examples, the upper rate of movement may depend on the data generation rate of the three-degree-of-freedom force sensor 220 of surface position sensor 100.

In another example, the sensor housing 210 is adapted to support a non-destructive sensor for sensing a physical characteristic of the tubular walled body as will be described below).

In another example, the sensor housing is rated in accordance with ingress protection standards to protect against the ingress of solid foreign objects, dust and/or water (eg, in accordance with IEC 6052). Depending on the sensing environment, an IP-rated element may be preferred. In one example, the sensor housing 210 and associated componentry is rated to IP67.

In one example, the sensor housing 210 or components mounted to the sensor housing such as ball bearings or the like are magnetic to magnetically couple to magnetic material in the tubular walled body, eg, a tubular walled body comprising a ferrous compound.

Referring again to FIG. 2 Surface position sensor 200 further comprises a three-degree of-freedom force sensor 220 for sensing circumferential movement of the sensor 200 as the sensor moves 200 across the surface of the elongate tubular walled body (eg, walled body 100 of FIG. 1).

In one example, three-degree of-freedom force sensor 220 is a non-contact force sensor having three or more axes of freedom that makes available a signal representative of the current circumferential position of the surface position sensor on the surface of the walled body.

In one example, the non-contact force sensor is an inclination sensor. In another example, the non-contact force sensor is an accelerometer/gyroscopic combination sensor. In another example, the non-contact force sensor is an accelerometer with Z-axis enabled or disabled. In one example, the non-contact sensor is configured as an integrated circuit (IC) chip which may be secured to or located internally within sensor housing 210.

In one example, three-degree-of-freedom force sensor 220 may comprise multiple sensors whose results are combined for determination of the circumferential position by processing module 230.

In one example, three-degree-of-freedom force sensor 220 is located inside sensor housing 210. In another example, three-degree-of-freedom force sensor 220 is attached to sensor housing 210. In another example, three-degree-of-freedom force sensor 220 is configured to be flush with an inner or outer surface of sensor housing 210.

Surface position sensor 200 also comprises a processing module 230 for receiving an output of the three-degree-of-freedom force sensor 220 and determining a current circumferential position on the surface as the surface position sensor moves across the surface of the elongate tubular walled body. In one example, processing module 230 receives the output from three-degree-of-freedom force sensor 220 and converts this to a current circumferential position of the sensor 200.

In one example, processing module 230 comprises a data processor in the form of a programmable microcontroller having associated memory, as well as multiple data inputs and outputs, including an output where the current circumferential position is made available and a control output to control the sensor indicator 240 as will be described below. In one example, the current circumferential position is outputted using standard pulse encoding methods such as quadrature (single or 4 edge) or step/direction encoding.

As would be appreciated, a processing module 230 need not comprise a single microcontroller but may comprise multiple separate control or processing modules each carrying out particular data processing or control task.

As would be appreciated, the current circumferential position of sensor 200 may be defined with respect to a starting location and potentially include an offset or compensation factor where the circumferential position of a component mounted to surface position sensor 200 is displaced circumferentially from the surface position sensor 200 and the circumferential position of this component is desired to be determined.

Surface position sensor 200 further comprises an indicator 240 for indicating a current positioning of the sensor relative to a reference circumferential position.

Considering the example of a substantially horizontally extending tubular walled body such as a pipe, the reference circumferential position may in one example be the top of the pipe. In one example, the indicator 240 provides a visual indication that changes appearance depending on the distance of the current circumferential position of the surface position sensor 200 from the reference circumferential position.

In one example, the visual indicator comprises a series or array of light emitting elements such as a light emitting diode (LED) or the like. In one example, individual light emitting elements, or combinations of light emitting elements, from the array of light emitting elements illuminate to indicate the distance and direction of the current circumferential position with respect to the reference circumferential position. In one example, 3 LEDs (although 5 LEDs could also be used) are all lit up, or the centre LED of the three LEDs is lit up, to indicate that surface position sensor 200 is located at a reference circumferential position such as the top of the tubular walled body. In this example, any movement of the surface position sensor 200 either side of the top location, and the side on which the sensor lies, is indicated by just one of the LEDs.

In one example, the array of 3 LEDs or light emitting elements can be linear and orientated orthogonally to the axial direction of the tubular walled body. Alternatively, a LED may be located on one side of the sensor housing 210, another LED located on the opposite side of the sensor housing 210, and a third LED is located centrally relative to the other two LEDs. The LEDs are preferably located so that an operator of sensor 200 can observe all three LEDs, either directly or with peripheral vision.

In one example, the indicator 240 may comprise a display (eg, a LCD or flat screen display) providing equivalent location information to the LEDs described above. In one example, the indicator 240 may display the determined current circumferential position (eg, a distance in mm).

In another example, the indicator 240 provides an audible indication. In one example, the audible indication is an audible signal that varies in pitch and/or intensity as the surface position sensor moves closer to or farther from the reference circumferential position.

In another example, the indicator 240 provides a tactile indication. In one example, the tactile indication comprises a vibrating element causing the sensor housing 210 to vibrate with increasing intensity the closer the current circumferential position of the sensor is to the reference circumferential position.

In another example, the indicator 240 may be any combination of visual, audible and/or tactile indication.

In one example, the indicator 240 may be located remote to surface position sensor 200 and information be provided to the remote indicator 240 by wireless communication means forming part of processing module 230.

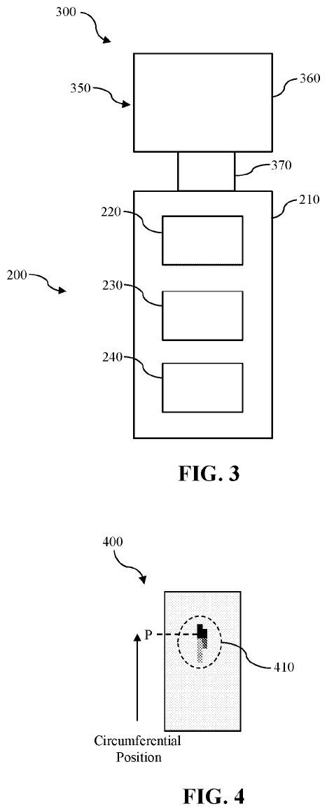

Referring now to FIG. 3, there is shown a system overview diagram of a sensing arrangement 300 for determining a physical characteristic around a circumferential portion of a tubular walled body comprising a non-destructive sensor 350 and incorporating the surface position sensor 200 illustrated in FIG. 2 according to some embodiments of the present disclosure.

In general, non-destructive sensors for non-destructive testing of structures such as a tubular walled body can involve the use of eddy currents, radiography, ultrasonic testing and other means. These types of sensing arrangements transmit energy (electromagnetic or sonic) to penetrate the walled body and then receive a proportion of the energy reflected off surfaces within the structure. These reflected signals are received and can be recorded for immediate or future analysis. There are many characteristics in the data collected that characterise the reflected energy, including the timing of the initial transmission and subsequent receipt of the reflection of that energy and the intensity of the transmitted energy relative to the intensity of the received reflected energy. Those characteristics can be captured, interpreted and compared. Conclusions can be drawn from the raw numerical data or from visualisations of that data which can indicate the condition of the structure, such as the wall condition.

There are many technological challenges in generating and receiving a particular type of energy. Most critical to that challenge is the accuracy and precision of detecting the available reflected energy representing the structure's condition. The person of skill in the art is knowledgeable of the type and specification of a non-destructive sensor best suited to provide data representative of the condition or conditions of a particular structure. Thus, there may be different energy types for different structures. Not only is the energy type a consideration, but as will be described later, the configuration of the non-destructive sensor elements (also described in this disclosure as a transceiver comprising an energy transmitter and an energy receiver combination) can depend to a degree on the apparatus that is adapted to carry the non-destructive sensor. Accordingly, for a given measurement or inspection task the energy type and configuration must be carefully considered, including the geometry of how that energy is transmitted and how the non-destructive sensor receives that energy following reflection from the structure. Also, the housing of the non-destructive transceiver needs to be carefully adapted due to the physical configuration of each structure.

In one example, non-destructive sensor 350 comprises a transceiver housing 360 and in one example a transceiver array operable to emit and receive energy through a sensor surface of the transceiver housing 360. In one example, the transceiver array is comprised of ultrasonic transducers operable to emit ultrasonic energy through the sensor surface of the transceiver housing 360 and into the tubular walled body and to receive reflected ultrasonic energy through the sensor surface. In one example, the transceiver array is a dual linear array of ultrasonic transducers. In another example, the transceiver array is a matrix array of ultrasonic transducers. In one example, the outer interface or sensor surface of the transceiver housing 360 is shaped in accordance with the curvature of the surface being measured, ie, the surface of the tubular walled body. In one example, the transceiver array is an array of ultrasonic transducers configured in a curved linear array having 128 transceiver elements adapted to create an ultrasonic beam directed towards and into a fluid-carrying or fluid-containment tubular walled body and to receive reflected ultrasonic energy from the fluid-carrying or fluid-containment walled body. In another example, transceiver housing 360 is rated to IP67.

In one example, the sensor housing 210 and/or transceiver housing 360 are configured to be mounted fixed with respect to each other by an adaptation arrangement 370. In one example, the adaption arrangement 370 comprises a support structure for the transceiver housing 360, which both locates the transceiver housing 360 on the sensor housing 210 and provides a mechanism to bias the interface or sensor surface of the transceiver housing 360 onto the surface of the walled body. In one example, the sensor surface of the transceiver housing 370 comprises a low-friction surface, and in another example, water or other suitable fluid is directed to flow between the interface surface of the transceiver housing 360 and the walled body to facilitate low-friction as the combined surface position sensor housing 210 and the transceiver housing 360 arrangement is moved over the surface of the walled body. In one example, the surface position sensor 200 is aligned to the location of the non-destructive sensor 350. In another example, any difference in circumferential positioning of the surface position sensor and non-destructive sensor is compensated for when the current circumferential position is determined by the processing module 230.

In another example, non-destructive sensor 350 may be integrated into sensor housing 210 to maintain the fixed relationship between the surface position sensor 200 and the non-destructive sensor 350 and form an integrated device.

The data output from the non-destructive sensor 350 represents the wall condition of tubular walled body at a given circumferential position corresponding to the location of the non-destructive sensor 350. In one example, the data output is made available in analogue form direct from the sensor 350. Although not infeasible to store analogue data, an analogue to digital transformation is typically applied to create a digital representation of the sensor output, which can then be made available for immediate review and is also typically stored for future analysis.

Sensing arrangement 300 further comprises a processing module 365 to receive the surface position from the surface position sensor 200 and the physical characteristic (eg, wall condition) from the non-destructive sensor and output the physical characteristic for a given surface position. As would be appreciated, processing module 365 may be located external or internal to non-destructive sensor 350 or form part of the functionality of processing module 230 of surface position sensor 200.

In one example mode of operation, as would be applicable to a tubular walled body in the form of a pipe, sensing arrangement 300 may be placed at the top of a pipe and then moved around the circumference of the pipe back to the starting location. In one example, the reference circumferential position of surface position sensor 200 may be set to the top of the pipe and an operator will move the sensing arrangement 300 around the circumference of the pipe until the indicator 240 of surface position sensor 240 indicates that the sensing arrangement 300 has returned to the top of the pipe. In another example, only a circumferential portion of the pipe may be desired to be tested.

In accordance with the present disclosure, data indicative of the physical condition of the wall measured by non-destructive sensor 350 at its current location will be directly correlated with the current circumferential position as determined by surface position sensor 200 as the sensing arrangement 300 is moved around the circumference of the pipe or more generally any tubular walled body. In this manner, the variation in the structural characteristics or wall condition of the pipe as a function of circumferential position may be determined and the exact circumferential position of any defect or structural issue in the tubular walled body may be determined from this information.

Referring now to FIG. 4, there is shown a visual representation 400 of the structural characteristics of a tubular walled body in the form of a pipe at a given axial location and showing the variation as a function of circumferential position (y-axis) as determined by ultrasonic testing according some embodiments of the present disclosure. In this example, the light grey pixels are representative of a structurally sound pipe wall, and the groupings of progressively darker pixels (see region 410 in FIG. 4) are representative of a discontinuity in the wall of the pipe located at approximately circumferential position P, which in this case, is caused by the degradation in wall condition resulting from corrosion of the inner wall.

In other examples, non-destructive sensor 350 may be based on use of electromagnetic energy (eg, use of eddy currents or magnetic flux leakage), and/or laser or x-ray energy.

Referring now to FIG. 5, there is shown a system overview diagram of a surface position sensor 500 for determining both a circumferential and axial position of the sensor on the surface of a tubular walled body according to some embodiments. Surface position sensor 500 is equivalent to surface position sensor 200 (as shown in FIG. 2) comprising a sensor housing 210, a three-degree-of-freedom force sensor 220, processing module 230, circumferential position indicator 240 but further comprises a translational sensor 550 for sensing movement of the sensor housing. Additionally, processing module 230 is further configured to receive an output from translational sensor 550 and for determining a current axial position on the surface as the surface position sensor 500 moves across the surface of the elongate tubular walled body. Processing module also includes a data output where the current axial position of the sensor 500 is made available and a control output to control the sensor indicator 240 in accordance with the current axial position as will be described below. In one example, the current axial position is outputted using standard pulse encoding methods such as quadrature (single or 4 edge) or step/direction encoding.

In one example, the translational sensor 550 comprises a translational encoder. As would be appreciated, translational or incremental encoders may be used to determine a body's position, speed, and direction by generating a pulse stream corresponding to displacement from a home position established as the starting position. In one example, the translation encoder is a rotary encoder having a quadrature coding output and preferably powered from a DC 0-volt to 5-volt source to create the high and low values of the output quadrature pulses. In one example, rotary encoder comprises an encoder wheel mounted to sensor housing 210. In one example, translation sensor, in the form of an encoder wheel, may be configured to retract or be raised within the sensor housing 210 to allow axial relocation or reorientation of the surface position sensor 500.

In various examples, the translational sensor 550 may be configured as a mechanical incremental rotary encoder type, magnetic encoder type, laser encoder type, or ball encoder type.

Similar to what was described with respect to indicator 240 indicating a current positioning of the surface position sensor relative to a reference circumferential position, indicator 240 or another indicator may be configured to indicate a current positioning of the surface position sensor 500 relative to a reference axial position and provide any combination of visual, audible and/or tactile indication to this effect.

As would be appreciated, the current axial position of sensor 500 may be defined with respect to a starting location and potentially include an offset or compensation factor where the axial position of a component mounted to surface position sensor 500 is displaced axially from the surface position sensor 500.

Accordingly, surface position sensor 500 functions to provide an updated axial and circumferential position of the sensor (or attached componentry) as it moves across the surface of a tubular walled body.

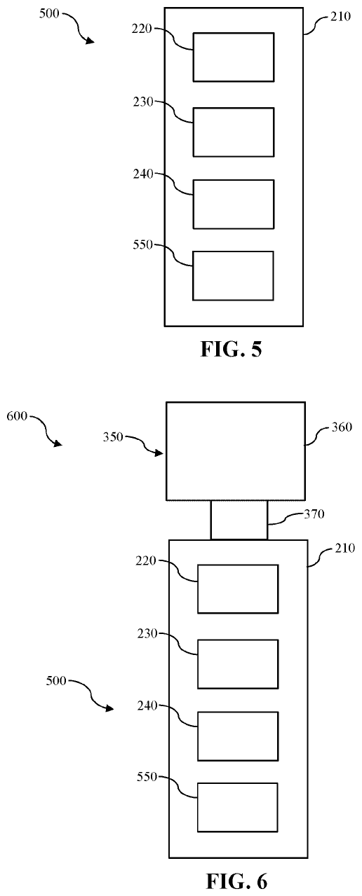

Referring now to FIG. 6, and by analogy with FIG. 3, there is shown a system overview diagram of a sensing arrangement 600 for determining a physical characteristic at a location on a tubular walled body comprising a non-destructive sensor and incorporating surface position sensor 500 illustrated in FIG. 5 according to some embodiments.

By comparison with sensing arrangement 300 illustrated in FIG. 3, sensing arrangement 600 also includes the ability to determine the axial position of the sensing arrangement 600 on the surface of the tubular walled body. Accordingly, in one example mode of operation, as would be applicable to a tubular walled body in the form of a pipe, sensing arrangement 600 may be placed at a selected circumferential position (eg, the top of the pipe) and sensing arrangement 600 may be moved axially along the top of the pipe and collect data for varying axial position of the sensing arrangement 600.

In one example, indicator 240 will indicate to an operator should the position of the sensing arrangement 600 vary in circumferential position (ie, pipe structural data is being sought for a constant circumferential position). Once a required axial distance has been traversed by sensing arrangement 600, the sensing arrangement 600 may be moved to a new circumferential position stepped from the original circumferential position and the sensing arrangement 600 then moved back to the starting axial position to scan the length of pipe at a different circumferential position. This procedure can be repeated multiple times to completely scan the pipe for structural issues. As would be appreciated, knowledge of circumferential and axial position will allow sensing arrangement 600 to be controlled to follow any predetermined path across the surface of the tubular walled body.

As surface position sensor 500 determines the current circumferential and axial position during the scanning process only the initial starting circumferential and axial position needs to be defined on the pipe in order to reference the measured structural data with the actual measured pipe. As an example, a starting location could be selected to be adjacent to a joint or a change of direction of the pipe for ease of reference.

Referring now to FIG. 7, there is shown a representation of a scanning process employing the sensing arrangement 600 illustrated in FIG. 6 according to some embodiments. In this example, sensing arrangement 600 traverses scanning path 700 comprising a first axial scan segment 700A followed by a first clockwise circumferential shift 700B and then a second return axial scan segment 700C followed by a second clockwise circumferential shift 700D followed by a third axial scan segment 700E in the original axial scan direction. In this manner, the scanned region 730 on the surface of tubular wall member 100 may be inspected in accordance with the present disclosure.

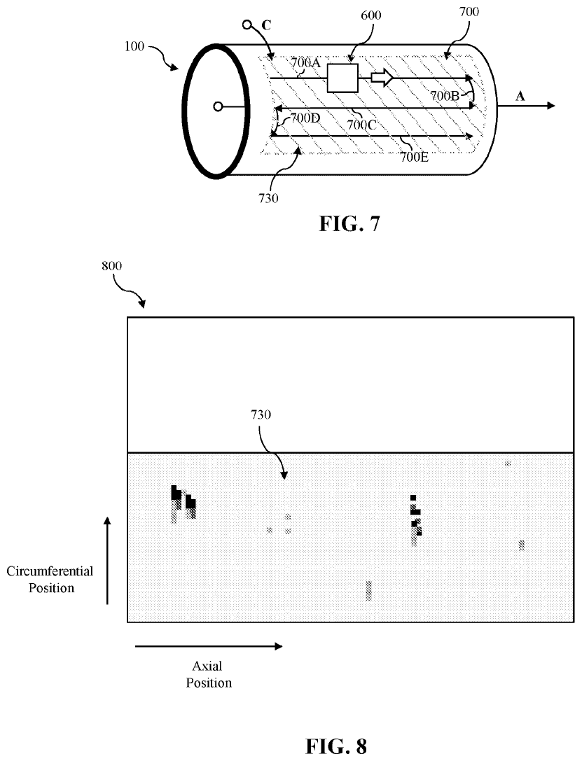

Referring now to FIG. 8, there is shown a visual representation 800 of the structural characteristics of a tubular walled body similar to FIG. 4 and in particular the scanned region 730 illustrated in FIG. 7. As can be seen by inspection, in this example the scanned region 730 corresponds to a portion of the full circumference that could be scanned.

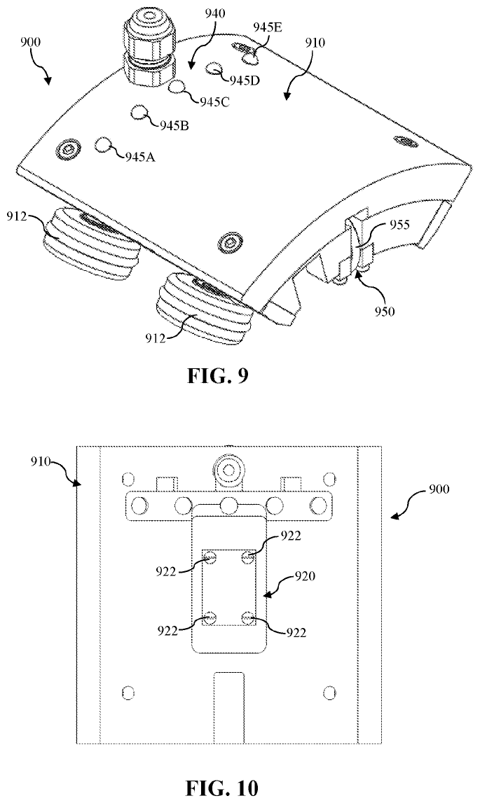

Referring now to FIG. 9, there is shown a top perspective view of a surface position sensor 900 according to some embodiments. In this example, surface position sensor 900 is configured to measure a tubular walled body in the form of a fluid containing structure such as a pipe having a diameter of 2″, 3″ or 4″. As would be appreciated, surface position sensor 900 may be modified to measure tubular walled bodies of differing constant curvatures (eg, cylindrical pipes of different diameters) to tubular walled bodies who have a varying curvature over the body (eg, an elliptical or non-regular shaped vessel or pipe).

Surface position sensor 900 comprises a sensor housing 910 for housing the sensor and sensing electronics and in this example has a part-arcuate configuration shaped to match the general curvature of the tubular wall body that is to be measured and which facilitates movement of sensor housing 910 across the surface of the tubular walled body. In this example, sensor housing 910 is formed from aluminium but other suitable rigid materials may be used depending on requirements.

Surface position sensor 900 further comprises a three-degree-of-freedom force sensor 920 for sensing circumferential movement of the sensor housing across the surface of the elongate tubular walled body which is shown in FIG. 10. In addition, surface position sensor 900 comprises a processing module (not shown) that receives output from three-degree-of-freedom force sensor 920 and determines the current circumferential position on the surface as surface position sensor 900 moves across the surface of the elongate tubular walled body being scanned or measured. In other examples, processing module may be located external to surface position sensor 900 and be communicatively coupled to force sensor 920

Surface position sensor 900 also comprises an indicator 240 for indicating a current position of sensor 930 relative to a reference circumferential position on the tubular walled body. In this example, indicator 240 provides a visual indication that changes appearance depending on a distance of the current circumferential position from the reference circumferential position. In this example, the visual indication is provided by 5 LEDs or equivalent lighting elements 945A-945E. In one example implementation, LED 745C would illuminate if the surface position sensor 930 is located at the reference circumferential position and LEDS 745B, 745A would progressively illuminate the more counterclockwise the location of the surface position sensor 900 is to the reference circumferential position. Similarly, LEDS 745D, 745E would progressively illuminate the more clockwise the location of the surface position sensor 900 is to the reference circumferential position.

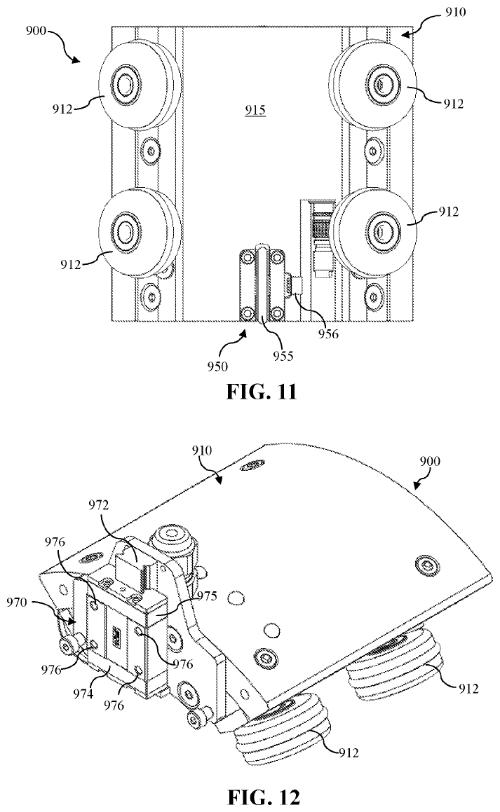

In this example, and as best seen in FIG. 11, surface position sensor 900 further comprises a translational sensor 950 for determining a current axial position on the surface of the tubular walled body. In this example, translational sensor comprises a translational encoder in the form of encoder wheel 955 mounted to sensor housing 910. In this example, encoder wheel has a diameter of 26 mm (including an outer urethane O-ring of 3 mm) implying a circumference of 81.7 mm.

As would be appreciated, the overall encoder wheel diameter is not critical as this operational characteristic is calibrated at the time of use and is nominally 12 pulses per mm. This arrangement generates 1024 pulses per revolution=12.5 pulses per mm. The maximum speed of the encoder is 30,000 rpm (500 rps), being 550*81.7=40.85 m/s. This equates to 1024*500=512,000 pulses per second and is quadrature encoded.

In the example of a manually moveable surface position sensor, it is expected that the sensor will be moved over the surface of the walled body at much the same pace as achievable by a person walking. For example, a 4-kilometre per-hour walking rate is about 1.1 meters per second, translating the data collection rate into a 12.5 kHz encoder rate at one m/s (meter per second) speed of movement of the apparatus across the surface of the structure being tested. A rotary encoder with the characteristics described could, if practical, travel at up to 41 m/s (150 km/hr).

Referring now to FIG. 10, there is shown an underside internal view of sensor housing 920 depicting the three-degree-of-freedom force sensor 930 according to some embodiments. In this example, three-degree-of-freedom force sensor 930 is mounted inside of sensor housing 920 and is in the form of an IC that is secured to housing 920 by screws 922.

Examples of a three-degree-of-freedom force sensor that may be suitable include non-contact force sensors including, but not limited to, an inclination sensor, an accelerometer/gyroscopic sensor combination, or an accelerometer with Z-axis enabled or disabled. In one example, the operation of the three-degree-of-freedom force sensor 920 may be momentarily disabled to prevent the sensor from providing an output pulse or a coded output such as when position sensor 900 is being moved vertically.

Referring now to FIG. 11, there is shown an underside view of surface position sensor 900 showing the translational sensor 950 according to some embodiments. In this example, translational sensor 950 in the form of encoder wheel 955 is fixed to sensor housing 910 by an over-centre clamp 956. In another example, a spring-loaded tongue can be used to allow and assist the rolling encoder wheel 955 in traversing over rough surfaces. In one example, a button or slide (not shown) can be used to raise the encoder wheel 955 when changing the orientation of surface position sensor 900 to control the engagement of the encoder wheel 955 with the wall body. In various examples, the encoder wheel will be configured to have sufficient travel and spring to resist side load force.

As shown in FIG. 11, sensor housing 910 comprises a sensor housing interface surface 915 configured to interface with the surface of the walled body to facilitate movement of the sensor housing 910 along or across the surface of the tubular walled body being measured. In this example, interface surface 915 has a part-arcuate concave configuration for measuring a pipe but equally the interface surface 915 may be formed to have a generally convex configuration if, as an example, an inner surface of a pipe or tubular walled body is being measured.

In this example, sensor housing interface surface 915 further comprises multiple low-friction interface wheels 912. Each wheel 912 has an axle fixed at a height from the bottom surface of the sensor housing 910 such that the outer surface of the wheel thereon is a distance achieved by the bias of the translation sensor 950 onto the surface of the walled body. Those low-friction interface members should maintain the interface surface 915 of the sensor housing 910 facing the tubular walled body to located at a distance that is not so great that the translation encoder 950 does not engage with the surface of the body or too small such that expected raised surface imperfections in the surface of the body cause the sensor housing 910 to scrape or become impeded by those imperfections as moves over that surface of the walled body. In an embodiment, each wheel 912 has a smooth outer surface at the interface between the wheel 912 and the surface of the tubular walled body. In one example, wheel 912 has an outer surface formed by an elastomeric material such as a neoprene or rubber O-ring. In an example, at least one wheel 912 is magnetic and arranged to magnetically couple to the walled body which is formed of a magnetic material.

FIG. 12 is an end on perspective view of the surface position sensor illustrated in FIG. 9 and further showing an additional adaptation arrangement 970 for mounting or attaching a non-destructive sensor in accordance with some embodiments. Adaption arrangement 970 comprises a support structure 975 for mounting the non-destructive sensor which both locates the non-destructive sensor on the sensor housing 910 and provides a biasing mechanism 977 to bias the interface or sensing surface of the non-destructive sensor onto the surface of the walled body. In this example, biasing mechanism 977 comprises a linear slide 972 along which slides a mounting block 974 which in this example is adjustable in height relative to sensor housing 910 to maintain the non-destructive sensor adjacent to the walled body once mounted to the mounting block 974. In an example, biasing mechanism 977 may comprise metallic spring or spring elements or equivalent elastomeric material to bias mounting block 974 downwardly.

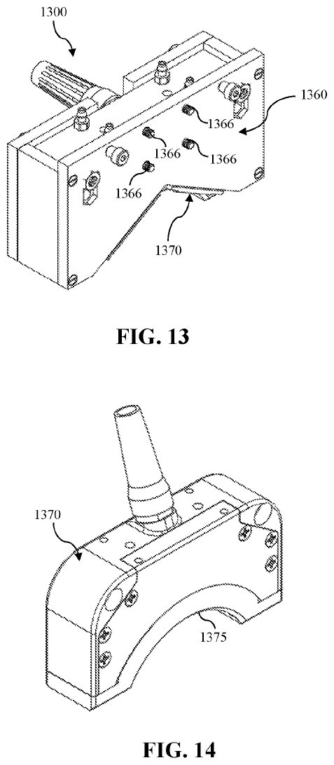

FIG. 13 is a top perspective view of a non-destructive sensor 1300 for non-destructive testing of a tubular walled body according to some embodiments. In this example, non-destructive sensor 350 comprises a transceiver housing 1360 and a transceiver array 1370 (as best seen in FIG. 14). As can be seen, transceiver housing 1360 is adapted for mounting to sensor housing mounting block 974 of adaptation arrangement 970 of sensor housing 910 using screws 1366 which engage with the corresponding threaded apertures 976 in sensor housing mounting block 974.

FIG. 14 is a top perspective view of a transceiver array 1370 forming the active detecting component of the non-destructive sensor illustrated in FIG. 13. Transceiver array 1370 comprises a number of ultrasonic transducers arranged radially about a part-arcuate sensor surface 1375 to form a curved array which is configured to be substantially the same shape as a portion of the surface of the tubular walled body that is being tested. As an example, the radius of curvature of sensor surface 1375 would be varied in accordance with the diameter of the pipe being tested. In this example, transceiver array 1370 comprises ultrasonic transducers having a 10 Mhz operating frequency and forming a concave azimuth array of 55 mm radius with the array having 64 elements, 96×3 mm total aperture, at 1.5 mm pitch, and 3 mm elevation.

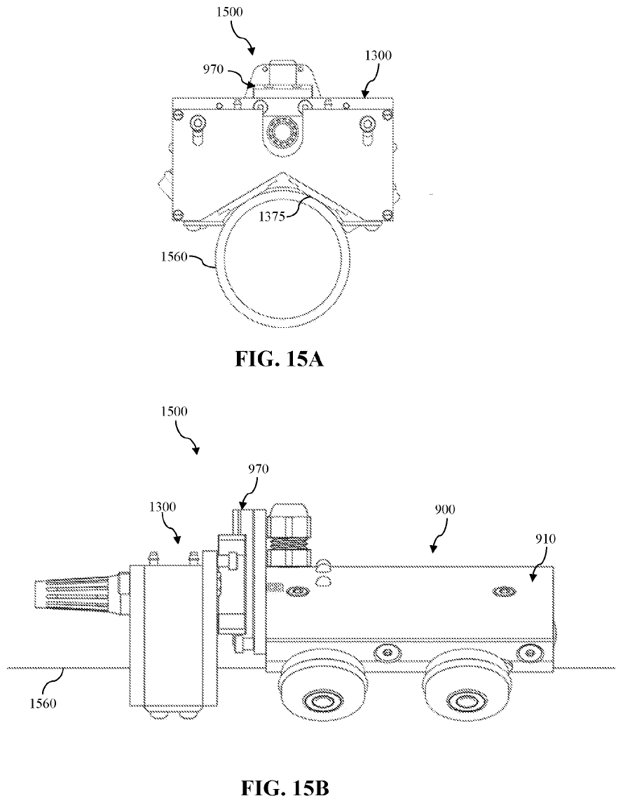

Referring now to FIGS. 15A and 15B, there are shown end and side views of a sensing arrangement 1500 for determining a physical characteristic of a tubular wall structure 1560 in accordance with some embodiments. In this example, sensing arrangement comprise surface position sensor 900 and non-destructive sensor 1300 and a processing module (not shown) to receive the surface position from the surface position sensor 900 and the physical characteristic from the non-destructive sensor 1300 and output the physical characteristic for a given surface position.

In one example, the processing module is located in either the sensor housing 910 or the transceiver housing 1360. In another example, the processing module is located externally from sensing arrangement 1500 and surface position and physical characteristic information is communicated to an external processing module which may include storage and display means and further the external processing module may provide power to sensing arrangement 1500.

In one example, a handle (not shown) is sized and located on sensing arrangement 1500 to permit an operate to manually operate sensing arrangement 1500 and any associated wiring loom over the tubular walled body. As would be appreciated, the ability for an operator to guide sensing arrangement 1500 over a tubular walled body results in a greater rate of testing than previous methodologies. By way of example, adopting the methodology shown in FIG. 7 the testing of any continuous length of pipe is achieved at least five times more quickly and furthermore the entire length of the pipe is tested. This may be contrasted with current scanning methods, which only test intermittently along the entire length of the pipe and included the possibility that some imperfections remained undetected. The ability of the surface position sensor 900 to determine precisely its own location (ie, circumferential and axial position) on the surface of a pipe means that all the piping structural data collected will be uniquely correlated to this location. This means that an operator may not need to precisely follow a scanning path so that the position can be inferred by reference to the scanning path but instead can rely on the location provided by surface position sensor 900.

In one example, to assist the manual movement of the apparatus over the surface of a tubular walled body, the surface position sensor weight can be compensated for by providing a magnetic coupling between the surface position sensor and the walled body (assuming that the structure is formed of a magnetic material).

In various examples. the surface position sensor may include hitching points so that a tow cable can be attached that can be used to pull the apparatus from its front or rear region. The draw rate can vary and is preferably the same or similar to the rate of manual movement. However, the rate of pull can be higher than the rate at which a person can manually move the apparatus over the structure, and the collection of characteristics of the structure can still be accommodated. Accordingly, some modes of use can result in the collection of data characteristic of the structure, which far exceeds the volume of data capture achievable with a person manually moving the surface position sensor. The ability of the apparatus to maintain proximity to the structure using a magnetic force, and then also be pulled along a path, allows for the collection of data characterising the structure in a circumstance where it may be dangerous, awkward or just inconvenient for a human operator to move sensing arrangement 1500 over the structure.

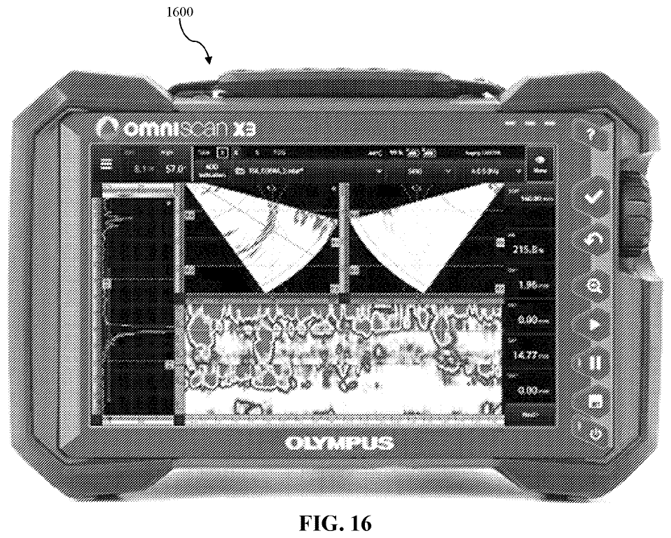

Referring now to FIG. 16, there is shown a representation of an external electronic data processing, display and control module 1600 that may be used in combination with a surface position sensor or sensing arrangement in accordance with the present disclosure and according to some embodiments.

In various examples, processing module may comprise:
a storage medium to store the data files and a method of copying and transferring the stored data to external media;
a replaceable battery for power;
digital data inputs to receive and analyse the encoder signals (eg, in quadrature form) used for generating the position determination;
pulser electronics to provide energy to any translational encoders and non-destructive sensors;
receiver electronics to receive the reflected energy and convert any analogue signal into a digital representation;
a display to display stored data or measured data in real time;
control inputs to allow an operator to initialise, control and manipulate the surface position sensor and/or sensing arrangement;
connectors to facilitate the connection of digital inputs and power and, in some cases, control signals to the surface position sensor and/or sensing arrangement; and/or
stored software code to process time-of-flight data from the non-destructive sensor transceiver or transceivers and correlate that data with the determined position of the surface position sensor.

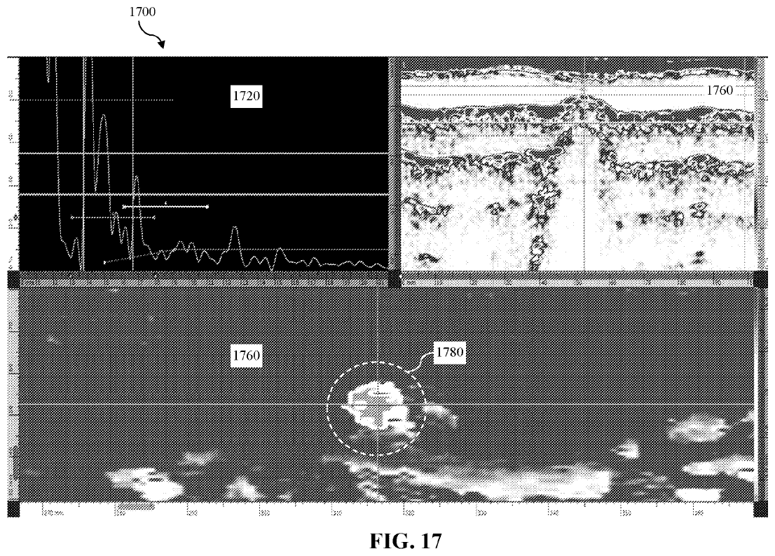

Referring now to FIG. 17, there is shown a composite display image 1700 showing a defect in a pipe and the location of the defect according to some embodiments.

Composite display image 1700 comprises an A-Scan image 1720 located at the top left showing a single channel digitised analogue response from an array of non-destructive ultrasonic sensor transceivers depicting an energy response based on time-of-fight within the pipe.

Composite display image 1700 further comprises a B-Scan image 1740 located at the top right where each A-scan 120 for every single channel of an array is stacked vertically, the topmost scan being positionally where the non-destructive ultrasonic sensor transceiver is closest to the pipe. Collectively, B-Scan image 1740 provides a visual representation of characteristics of a particular length segment of the tested pipe.

Composite display image 1700 additionally comprises a C-Scan image 1760 at the bottom which depicts a composite image of each A-scan with its corresponding correlated position along the pipe, where the processed data indicates discontinuities in the pipe more easily than examining the raw data. In the C-Scan image, the dark grey colour indicates the full wall thickness of the pipe, lighter colours indicate changes in the thickness of the pipe, and a discrete change from dark grey to light grey (eg, see region 1780) indicates a considerable wall thickness reduction compared to the dark grey region. Reduction of wall thickness is indicative of pitting or localised corrosion. The lineal location of the depicted reduction of thickness in the pipe wall is shown in the gauge along the bottom of the screen, as between 310 and 320 mm from the start position this particular pipe.

Some embodiments described herein may be implemented using programmatic elements, often called modules or components, although other names may be used. Such programmatic elements may include a program, a subroutine, a portion of a program, a software component or a hardware component capable of performing one or more stated tasks or functions.

A processor, module or component can exist as a hardware component operating independently of other processors, modules or components. The processor, module or component can be a shared element or process of other processors, modules or components, programs or machines. A processor, module or component may reside on one machine, such as on a client or a computer server. A processor, module, or component may be distributed amongst multiple machines, such as on multiple clients or computer server machines. Any system described may be implemented in whole or in part on a computer server or as part of a network service. Alternatively, a system described herein may be implemented on a local computer, computer processor, computer terminal, or server in whole or part. In either case, implementation of the system provided for in this application may require the use of memory, processors and network resources, including data ports and signal lines (wired, optical, wireless electromagnetic and other communication modalities), unless stated otherwise. Each program executed on a processor changes the state of the processor and makes it perform an action that is, in some cases, unique for the operation of the processor when performing the actions defined by the program. The changed state of the computer interacts with peripherals, and those actions may be unique to the peripheral.

Some embodiments described herein may generally require computers and computer processors, including processing and memory resources. For example, when collecting data relating to the circumferential and axial location of the surface position sensor with respect to the tubular walled body and storage, retrieval and correlation of that positional data with data detected by one or more sensors relating to one or more characteristics of the walled body. Systems described in accordance with the present disclosure may be implemented on the apparatus or on a device remote but linked to the apparatus or a server or networked computer service remote from the apparatus.

The processing may occur at the time of collection or in the future. The remote computer or computer servers may connect and be used by users over networks such as the Internet or by a combination of networks, such as cellular networks and the Internet or communicated using one or more wireless protocols and one or more carrier technologies such as WiFi, Bluetooth, WiMax, etc. Alternatively, one or more embodiments described in accordance with the present disclosure may be implemented locally, in whole or in part, on computing machines such as desktops, cellular phones, personal digital assistances or laptop computers. Thus, memory, processing and network resources may all be used in connection with the establishment, use or performance of any embodiment of a method or system described herein, specifically including the performance of embodiments of a method or implementation of a system or the construction of a position-determining apparatus.

Furthermore, some embodiments described in the present disclosure may be implemented using instructions that are executable by one or more processors. These instructions may be carried on a computer-readable medium that is transitory and non-transitory. Machines that may be shown in the figures provide examples of processing resources and computer-readable mediums on which instructions for implementing embodiments can be carried out and executed. In particular, the numerous machines associated with one or more embodiments include a processor(s) and various forms of memory for holding data and instructions. Examples of computer-readable mediums include permanent memory storage devices, such as hard drives on personal computers or computer servers. Other examples of computer storage mediums include portable storage units, such as CD or DVD units, flash memory (such as carried on many cell phones and personal digital assistants (PDAs), and magnetic memory. Computers, terminals, and network-enabled devices (e.g. mobile devices such as cell phones) are all examples of processors and devices. Instructions are usually stored on transitory and non-transitory computer-readable mediums, including RAM, ROM and EPROM devices.

The present disclosure can be implemented in numerous ways, including as an apparatus, a system, a process, or a computer-readable medium such as a computer-readable storage medium or a computer network wherein program instructions and digital data files are sent over wired, wireless, optical, or electronic communication links. It should be noted that the order of the steps of disclosed processes may be altered within the scope of the disclosure. Details concerning computers, computer networking, software programming, telecommunications and the like may at times not be illustrated explicitly as such was not considered necessary to obtain a complete understanding nor to limit a person skilled in the art of performing the embodiments, but are considered present nevertheless, as such are considered to be within the skills of persons of ordinary skill in the art.

The reference to any prior art in this specification is not, and should not be taken as, an acknowledgement or any form of suggestion that such prior art forms part of the common general knowledge.

It will be understood that the terms “comprise” and “include” and any of their derivatives (e.g. comprises, comprising, includes, including) as used in this specification, and the claims that follow, is to be taken to be inclusive of features to which the term refers, and is not meant to exclude the presence of any additional features unless otherwise stated or implied.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1. A surface position sensor comprising:
a sensor housing moveable across a surface of an elongate tubular walled body, the elongate tubular walled body defining an axial direction extending along a length of the walled body and a transverse circumferential direction extending along a circumference of the walled body;
a three-degree-of-freedom force sensor for sensing circumferential movement of the sensor housing across the surface of the elongate tubular walled body;
a processing module for receiving an output of a three-degree-of-freedom force sensor and determining a current circumferential position on the surface as the surface position sensor moves across the surface of the elongate tubular walled body; and
an indicator for indicating a current positioning of the surface position sensor relative to a reference circumferential position.

2. The surface position sensor of claim 1, wherein the sensor housing comprises a housing interface surface configured to facilitate movement of the sensor housing across the surface of the elongate tubular walled body.

3. The surface position sensor of claim 2, wherein the sensor housing interface surface comprises a low-friction surface.

4. The surface position sensor of claim 2, wherein the sensor housing interface surface is shaped in accordance with the curvature of the surface being measured.

5. The surface position sensor of claim 1, wherein the sensor housing is configured to be manually moveable across the surface of the elongate tubular walled body.

6. The surface position sensor of claim 1, wherein the surface position sensor further comprises a motive force arrangement adapted to move the sensor across the surface of the elongate tubular walled body.

7. The surface position sensor of claim 1, wherein the indicator provides a visual indication that changes appearance depending on a distance of the current circumferential position from the reference circumferential position.

8. The surface position sensor of claim 7, wherein the visual indication comprises an array of light emitting elements and wherein individual light emitting elements, or combinations of light emitting elements, illuminate to indicate the distance and direction of the current circumferential position with respect to the reference circumferential position.

9. The surface position sensor of claim 1, wherein the three-degree of-freedom force sensor is a non-contact force sensor.

10. The surface position sensor of claim 1, further comprising a translational sensor for sensing axial movement of the sensor housing and wherein the processing module is further configured to receive an output from the translational sensor and determine a current axial position on the surface as the surface position sensor moves across the surface of the elongate tubular walled body.

11. The surface position sensor of claim 10, wherein the translational sensor is a rotary encoder type sensor.

12. The surface position sensor of claim 10, wherein the indicator indicates the current positioning of the surface position sensor relative to a reference axial position.

13. The surface position sensor of claim 1, wherein the tubular walled body is a fluid carrying pipe.

14. A sensing arrangement for determining a physical characteristic of a tubular wall structure, comprising:
the surface position sensor of claim 1;
a non-destructive sensor operable to sense the physical characteristic of the tubular wall structure at a given surface position; and
a processing module to receive the surface position from the surface position sensor and the physical characteristic from the non-destructive sensor and output the physical characteristic for a given surface position.

15. The sensing arrangement of claim 14, wherein the non-destructive sensor comprises:
a transceiver housing having a sensor surface;
a transceiver array operable to emit and receive energy through the sensor surface, wherein the sensor surface is shaped in accordance with the curvature of the surface being measured.

16. The sensing arrangement of claim 15, wherein the transceiver array comprises ultrasonic transducers operable to emit ultrasonic energy through the sensor surface and into the tubular walled body and to receive reflected ultrasonic energy through the sensor surface.

17. The sensing arrangement of claim 14, wherein the sensor surface is biased to contact with the surface of the tubular walled structure being sensed.

18. The sensing arrangement of claim 17, wherein the physical characteristic of the tubular wall structure is the wall condition.

19. The sensing arrangement of claim 14, wherein the sensor arrangement is configured to be manually moveable across the surface of the elongate tubular walled body.

20. A method for determining the condition of a tubular walled body, comprising:
moving the sensor arrangement of claim 14 in accordance with a predetermined path covering a representative surface portion of the tubular walled body; and
determining the condition based on the variation in the physical characteristic measured by the sensor arrangement.
